(19) United States
(12) Patent Application Publication
(10) Pub. No.: US 2015/0109545 A1
(43) Pub. Date: Apr. 23, 2015

(54) ITO FILM AND TERMINAL INCLUDING SAME

(71) Applicant: Xiaomi Inc., Beijing (CN)

(72) Inventors: Yuan Gao, Beijing (CN); Hongzhi Jin, Beijing (CN); Gaocai Han, Beijing (CN)

(73) Assignee: Xiaomi Inc.

(21) Appl. No.: 14/471,627

(22) Filed: Aug. 28, 2014

Related U.S. Application Data
(63) Continuation of application No. PCT/CN2014/077466, filed on May 14, 2014.

(30) Foreign Application Priority Data
Oct. 18, 2013 (CN) 201310492710.6

(51) Int. Cl. G02F 1/1335; G02F 1/1333; G02B 5/02

(52) U.S. Cl. CPC G02F 1/133504; G02B 5/0273; G02F 1/13338
USPC 349/12; 359/599

(57) ABSTRACT

A terminal includes: a processor; a memory for storing instructions executable by the processor; and a touch panel including a transparent cover plate, an indium tin oxide (ITO) film, and a liquid crystal display (LCD) module; wherein the transparent cover plate is attached to the LCD module; and the ITO film is provided with patterns configured to diffuse light and is attached to the transparent cover plate, an attaching position being located in a button region of the terminal.

### CROSS-REFERENCE TO RELATED APPLICATIONS

This application is a continuation of International Application No. PCT/CN2014/077466, filed May 14, 2014, which is based upon and claims priority to Chinese Patent Application No. 201310492710.6, filed Oct. 18, 2013, the entire contents of all of which are incorporated herein by reference.

### TECHNICAL FIELD

The present disclosure generally relates to the electronic technology field and, more particularly, to an ITO film and a terminal including the ITO film.

### BACKGROUND

With the development of the electronic technology, terminals with full touch screens have been very popular. Moreover, for the overall aesthetics of terminals, a button area has been realized as a touch button area.

Conventionally, an indium tin oxide (ITO) film is used to realize a touch screen area and a touch button area. The ITO thin film is an N-type semiconductor material with high conductivity, high visible light transmittance, high mechanical hardness and excellent chemical stability. Thus, the ITO film is a common film material for a liquid crystal display (LCD), a plasma display panel (PDP), an electroluminescent organic light emitting diode (EL/OLED), a touch panel, a solar cell, and transparent electrodes of electronic instruments.

Buttons in the button area are generally dark without touching and are lighted upon being touched. In general, a light guide film (LGF) is used to balance a brightness of each of the buttons. The LGF is a product that can convert a point light source of LED into an area light source. The LGF has characteristics of ultra thin, uniform luminance and various colors and the like, and may be used in the backlight of a mobile phone keypad.

If the ITO film and the LGF are stacked to be used in a terminal, a thickness of the terminal will increase.

### SUMMARY

According to a first aspect of the present disclosure, there is provided an indium tin oxide (ITO) film, comprising: patterns configured to diffuse light.

According to a second aspect of the present disclosure, there is provided a terminal, comprising: a processor; a memory for storing instructions executable by the processor; and a touch panel including a transparent cover plate, an indium tin oxide (ITO) film, and a liquid crystal display (LCD) module; wherein the transparent cover plate is attached to the LCD module; and the ITO film is provided with patterns configured to diffuse light and is attached to the transparent cover plate, an attaching position being located in a button region of the terminal.

It should be appreciated that, the above general description and the detailed description below are merely exemplary, and do not limit the disclosure.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1A is a schematic view of an ITO film, according to an exemplary embodiment.

FIG. 1B is a schematic view of an ITO film, according to an exemplary embodiment.

FIG. 2A is a side sectional view of an ITO film, according to an exemplary embodiment.

FIG. 2B is a side sectional view of an ITO film, according to an exemplary embodiment.

FIG. 3 is a schematic view of a terminal, according to an exemplary embodiment.

FIG. 4A is a schematic view of a terminal, according to an exemplary embodiment.

FIG. 4B is a schematic view of a terminal, according to an exemplary embodiment.

FIG. 5 is a schematic view of a terminal, according to an exemplary embodiment.

FIG. 6 is a schematic view of a button region, according to an exemplary embodiment.

FIG. 7 is a schematic view of a button region, according to an exemplary embodiment.

FIG. 8 is a block diagram of a terminal, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

An indium tin oxide (ITO) film and a terminal including the ITO film are provided in the present disclosure. In exemplary embodiments, the ITO film and a light guide film (LGF) are combined together, thus a thickness can be reduced.

The ITO film is an N-type semiconductor material based on a polyethylene terephthalate (PET) film. The PET film is also referred to as a polyester film with high-temperature resistance, which has excellent physical property, chemical property, dimensional stability, transparency and recyclability, and can be widely applied in the fields of magnetic recording, photographic materials, electronics, electrical insulation, industrial films, packaging decoration, etc. Moreover, the LGF is also based on the PET film. Thus, the ITO film and the LGF can be combined together, so as to obtain the ITO film with patterns configured to diffuse light.

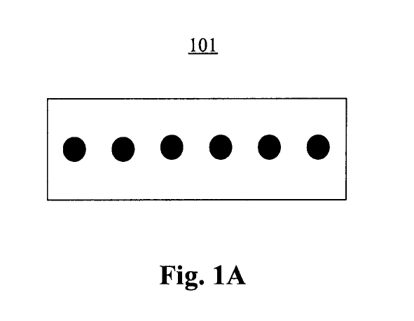

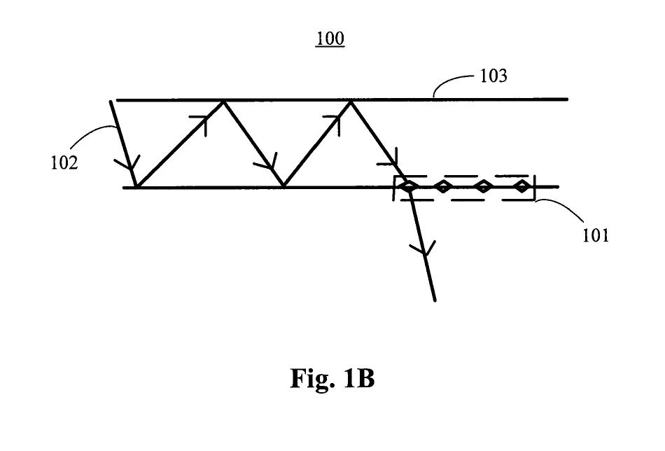

FIG. 1A is a schematic view of patterns 101 on an ITO film (not shown), according to an exemplary embodiment. Referring to FIG. 1A, the ITO film includes the patterns 101 configured to diffuse light. To clearly illustrate the patterns 101 configured to diffuse light, the ITO material is not shown in FIG. 1A.

FIG. 1B is a schematic diagram of an ITO film 100, according to an exemplary embodiment. Referring to FIG. 1B, the ITO film 100 includes a PET layer 103, on which the patterns 101 (FIG. 1A) for diffusing light are implemented. While the PET layer 103 is thin, the PET layer 103 still has a thickness of, e.g., about 0.1 mm. Under illumination conditions, at least a part of light 102 is totally reflected within the PET layer 103. As shown in FIG. 1B, the light 102 is directly totally reflected by upper and lower surfaces of the PET layer 103. An angle of incidence or a material density can be changed to change a refractive index, when the light 102 is needed to be emitted out from the PET layer 103. In this embodiment, a position from which the light 102 is emitted out is a position where the patterns 101 are located. An exemplary manner of changing the angle of incidence is providing concave points, or convex points, or concave points and convex points (collectively referred to as “the points”) to form the patterns 101 on the surface of the PET layer 103, such that the angle of incidence of the light 102 on the points does not meet a condition of total reflection. An exemplary manner of changing the material density is printing other material on the surface of the PET layer 103 to form the patterns 101, a density of the printed material being larger than the material density of the PET layer 103. The detailed structure of the ITO film 100 is provided in the following embodiments.

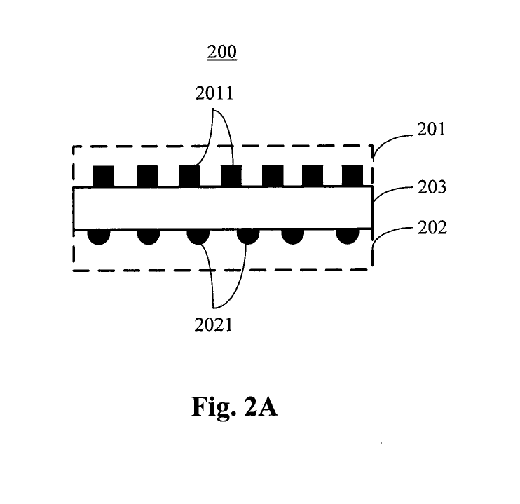

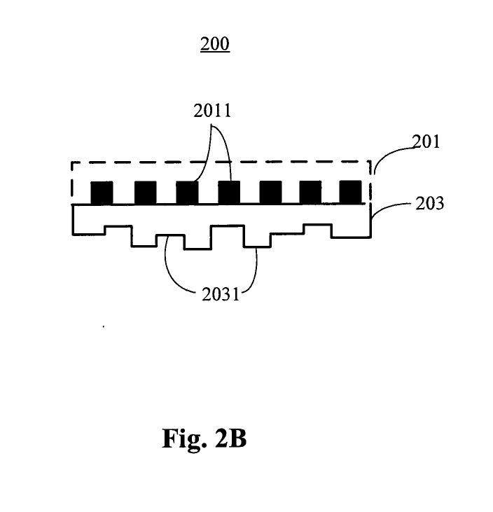

FIG. 2A is a side sectional view of an ITO film 200, according to an exemplary embodiment. Referring to FIG. 2A, the ITO film 200 includes an ITO layer 201, a light conducting material layer 202, and a PET layer 203. The ITO layer 201 and the light conducting material layer 202 are respectively attached to first and second sides of the PET layer 203. In addition, patterns are provided on the light conducting material layer 202.

The ITO layer 201 consists of a plurality of transparent electrodes 2011 made from ITO material. A shape and a distribution of the transparent electrodes 2011 are related to the conductivity thereof, and can be designed as required.

The light conducting material layer 202 consists of a plurality of light conducting points 2021 made from light conducting material to form patterns. The patterns of the respective light conducting points 2021 may be the same or different with each other. The distribution of the respective light conducting points 2021 may be uniform or not. The areas and shapes of the respective light conducting points 2021 may be varied. Light will be totally reflected and diffused when hitting on the light conducting points 2021. The more densely the patterns are distributed within the light conducting points 2021 and the closer the light conducting points 2021 are with each other, the more light is reflected. The material of the light conducting points 2021 may be ink material which does not absorb light and, thus, a better effect of light reflecting can be obtained.

The material of the PET layer 203 can be polycarbonate (PC) or PMMA resin, etc.

FIG. 2B is a side sectional view of the ITO film 200, according to another exemplary embodiment. Referring to FIG. 2B, the ITO film 200 includes the ITO layer 201 and the PET layer 203 (FIG. 2A).

In addition, concave points and convex points 2031 are provided on a side of the PET layer 203 opposite to the ITO layer 201, to form the patterns configured to diffuse light.

It may save the light conducting material and further reduce the thickness of the ITO film that the side of the PET layer 203 is provided with the concave points and convex points 2031.

The shapes of the concave points and convex points 2031 are not limited to square, circle or other shapes. The sizes of the respective concave points and convex points 2031 may be the same or different with each other. The heights of the concave points and convex points 2031 are related to the reflection effect and can be determined according to actual needs. The concavity of the concave points and the convexity of the convex points may be a plane, a curved surface or a v-shaped surface, etc.

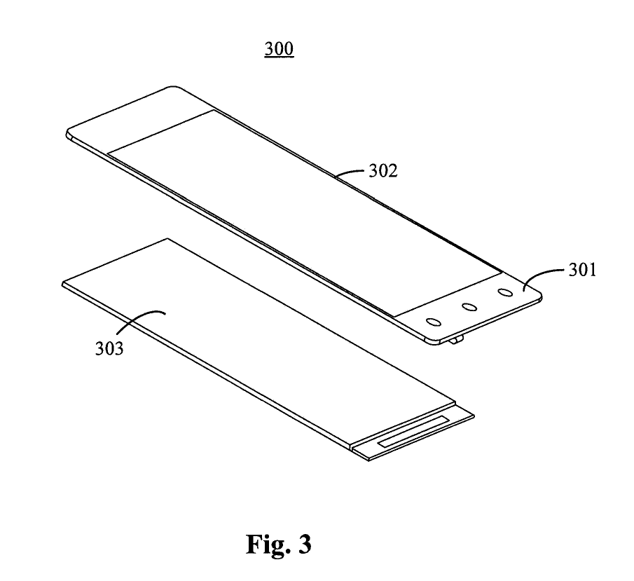

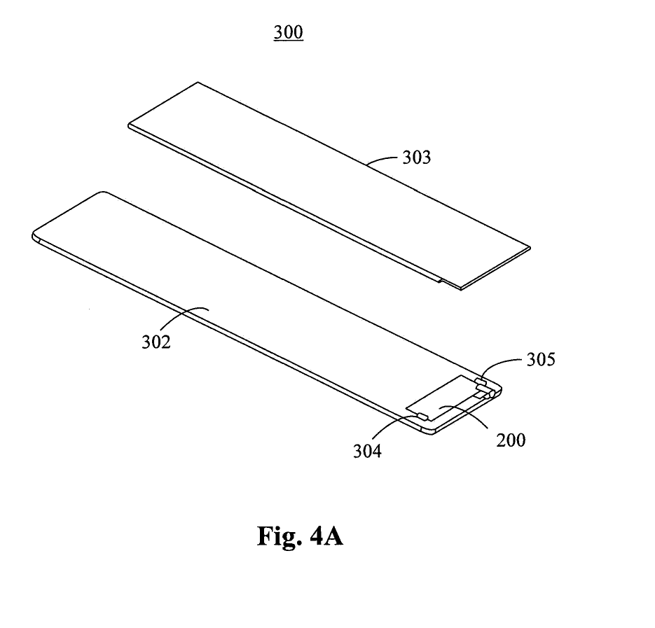

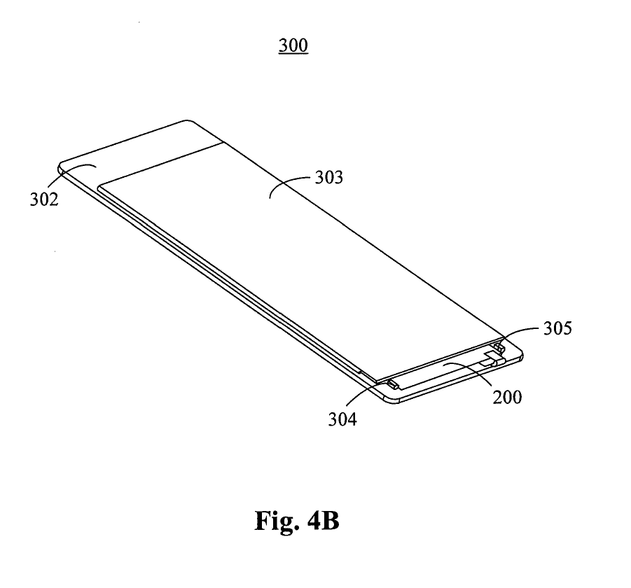

The ITO film in the above embodiments can be used in a terminal to reduce a thickness thereof. FIGS. 3, 4A, and 4B are schematic views of a terminal 300, according to an exemplary embodiment. Referring to FIGS. 3, 4A, and 4B, the terminal 300 includes a touch panel that further includes a transparent cover plate 302, an ITO film such as the ITO film 200 (FIG. 2), and a liquid crystal display (LCD) module 303.

The transparent cover plate 302 is attached to the LCD module 303. The LCD module 303 includes a display region and a drive region, and the display region of the LCD module 303 is attached to the transparent cover plate 302. There is a gap between the drive region of the LCD module 303 and the transparent cover plate 302 due to different thicknesses of the display region and the drive region of the LCD module 303. The drive region of the LCD module 303 is located in a button region 301.

The ITO thin film 200 has patterns configured to diffuse light and is attached to the transparent cover plate 302. The attaching position is in the button region 301 of the terminal 300.

The button region 301 includes icons of function buttons, such as a menu button, a back button, a home button, and the like. The menu button, the back button, and the home button can be realized through the transparent electrode 2011 included in the ITO film 200 (FIG. 2).

By providing the ITO film 200 with the patterns configured to diffuse light in the button region 301, a thickness of the button region 301 can be reduced and the buttons can have good effects of touching and displaying.

If an ITO film and a LGF are used, they cannot be provided in the gap between the drive region of the LCD module 303 and the transparent cover plate 302 due to a large thickness and, thus, the ITO film cannot be used in the button region 301. However, in the present embodiment, the ITO film 200 is sufficiently thin and has the properties of both the ITO film and the LGF, so that the ITO film 200 can be provided in the gap, thereby being applied in the button region 301.

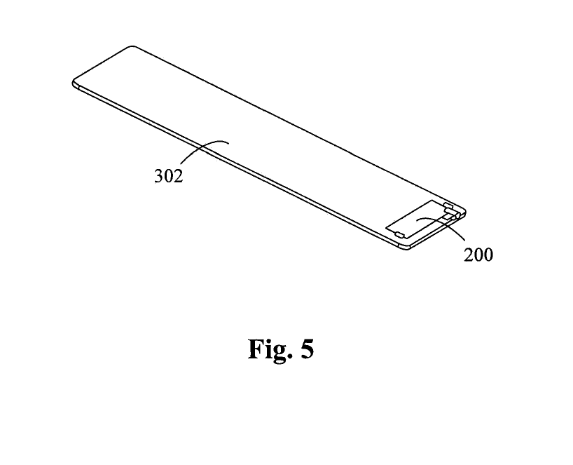

FIG. 5 is a view of a portion of the touch panel of the terminal 300 (FIGS. 3, 4A, and 4B). As shown in FIG. 5, the ITO film 200 is attached to the transparent cover plate 302 in the present embodiment, so that the position of the ITO film can be easily fixed. Moreover, the ITO film 200 can be attached in the manufacturing process of the transparent cover plate 302.

The transparent cover plate 302 may be a cover glass and has good transparency and hardness. The manufacturing process of the transparent cover plate 302 is simple and the cost is low.

If the ITO film 200 includes the light conducting material layer 202 (FIG. 2A), the light conducting material layer 202 is attached to the transparent cover plate 302 so as to facilitate circuit design of the ITO layer.

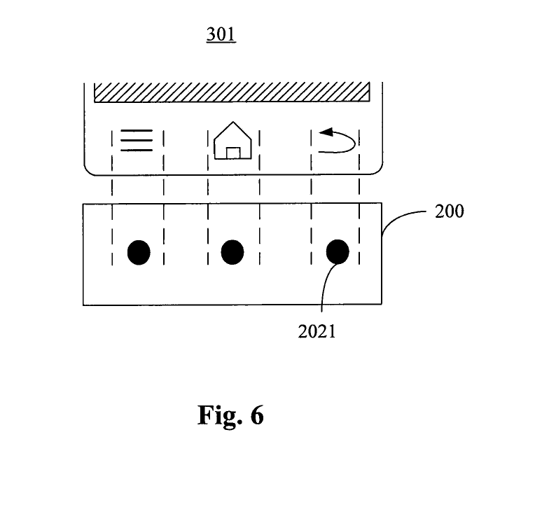

FIG. 6 is a schematic view of the button region 301 (FIG. 3), according to an exemplary embodiment. Referring to FIG. 6, in the button region 301, the distribution of the patterns of the light conducting points 2021 corresponding to the positions with buttons on the ITO film 200 is denser than that corresponding to the positions without buttons, which can improve the display uniformity of the light on the buttons.

If the ITO film 200 does not include the light conducting material layer 202 (FIG. 2B), the PET layer 203 is attached to the transparent cover plate 302. The concave points and convex points are provided on the side where the PET layer 203 is attached to the transparent cover plate 302, and form the patterns. In the button region 301, the distribution of the concave points and convex points on the buttons is denser than that on the positions without buttons, which can improve the display uniformity of the light on the buttons.

Referring to FIG. 4B, the terminal 300 further includes at least one light emitting element which is located on a side of the button region 301. In the illustrated embodiment, first and second light emitting elements 304 and 305 are located on two sides of an extending direction of the button region 301. For example, the light emitting elements 304 and 305 may be light emitting diodes (LED). The light emitting elements 304 and 305 may be attached on the ITO film 200 so as to light the button region 301.

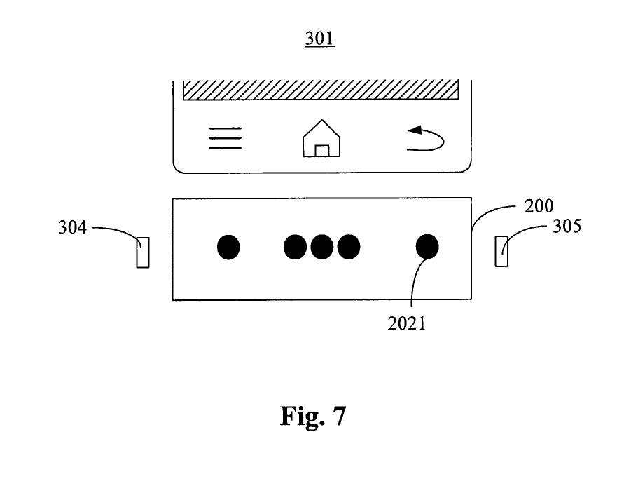

FIG. 7 is a schematic view of the button region 301 (FIG. 3), according to an exemplary embodiment. The farther away the patterns of the light conducting points 2021 on the ITO film 200 are from the light emitting elements 304 and 305, the distribution of the patterns on the ITO film 200 become denser, which can further improve the display effect.

In exemplary embodiments, the PET layer 203 (FIGS. 2A and 2B) includes colored material to realize the color effect of the buttons.

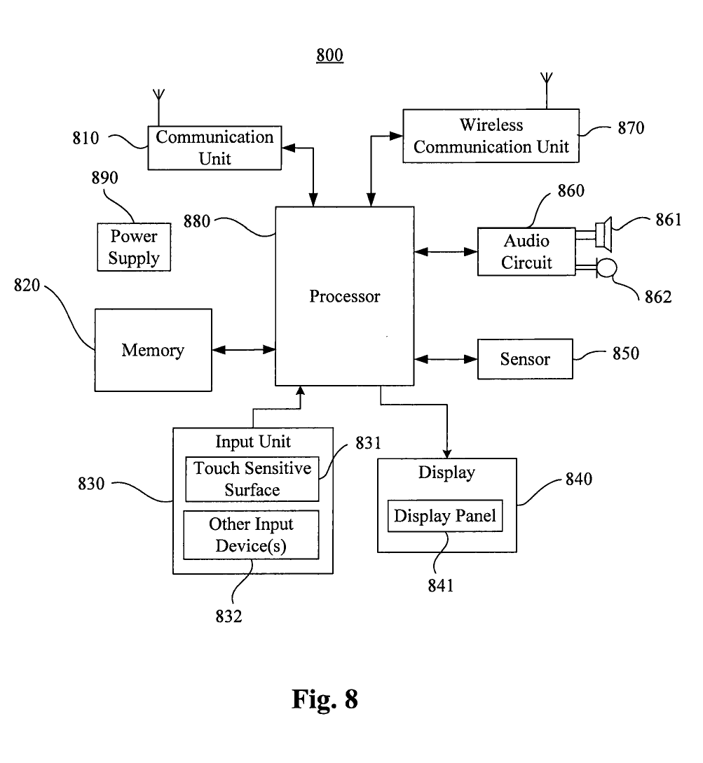

FIG. 8 is a block diagram of a terminal 800, according to an exemplary embodiment. Referring to FIG. 8, the terminal 800 may include one or more of a communication unit 810, memory resources represented by a memory 820, an input unit 830, a display 840, a sensor 850, an audio circuit 860, a wireless communication unit 870, a processor 880 including one or more process cores, a power supply 890 and the like. Those skilled in the present art will understand that the terminal 800 is not limited to the structure shown in FIG. 8, and the terminal 800 may include more or less components, or a combination of some components, or have different component arrangements.

The communication unit 810 is configured to transmit and receive signals during transmitting and receiving of information or a process of calling. The communication unit 810 may be a network communication device such as a radio frequency (RF) circuit, a router, a modem and the like. For example, if the communication unit 810 is the RF circuit, the communication unit 810 receives downlink information from a base station and then transmits the downlink information to the processor 880 to be processed, and transmits the related uplink data to the base station. Generally, the RF circuit as the communication unit 810 includes, but is not limited to, an antenna, at least one amplifier, a tuner, one or more oscillators, a subscriber identity module (SIM) card, a transceiver, a coupler, a low noise amplifier (LNA), a duplexer and the like. Additionally, the communication unit 810 may also communicate with a network or other devices via a wireless network. The wireless network may adopt any communication standard or protocol including, but not limited to, global system of mobile communication (GSM), general packet radio service (GPRS), code division multiple access (CDMA), wideband code division multiple access (WCDMA), long term evolution (LTE), email, short messaging service (SMS) and the like.

The memory 820 is configured to store programs and modules software programs and modules, which allow various types of functional applications and data processes to be performed when executed by the processor 880. The memory 820 may mainly include a program storage area and a data storage area. The program storage area may store an operating system, applications required by at least one required functions (such as a voice play function, an image play function and the like). The data storage area may store data (such as video data, phonebook data, and the like) created by the terminal 800. In addition, the memory 820 may include a high speed random access memory. The memory 820 may also include a nonvolatile memory (NVM), such as at least a magnetic disk storage device, a flash memory or other nonvolatile solid-state storage devices. Correspondingly, the memory 820 may also include a memory controller to control access to the memory 820 performed by the processor 880 and the input unit 830.

The input unit 830 is configured to receive input numerical or character information and generate signal inputs through a keypad, a mouse, an operation rod, optical or trackball related to user settings and function control. The input unit 830 may include a touch sensitive surface 831 and one or more other input devices 832. The touch sensitive surface 831, also called a touch display screen or a track pad, may collect a touch operation on it or near it by the user (for example, the user operations on or near the touch sensitive surface 831 with any kind of suitable objects or attachments such as a finger, a touch pen, and the like), and drive a corresponding connected device according to a preset program. The touch sensitive surface 831 may include first and second parts, i.e., a touch detecting device and a touch controller. The touch detecting device may detect the touch orientation of the user, and detect the signal caused by the touch operation, and then transmit the signal to the touch controller. The touch controller may receive the touch information from the touch detecting device and convert it into touch point coordinates and then transmit the coordinates to the processor 880. The touch controller also receives and performs instructions from the processor 880. Additionally, the touch sensitive surface 831 may be realized in various types such as a resistive type, a capacitive type, an infrared type, or a surface acoustic wave type and the like. The input unit 830 may also include one or more other input devices 832. The other input device 832 may include, without limitation, one or more of a physical keypad, functional buttons (such as volume control button, switch button and the like), a trackball, a mouse, a joystick, and the like.

The display 840 is configured to display various kinds of graphic user interfaces and information input by the user or provided to the user. These graphic user interfaces may be made up of graphics, texts, icons, videos and any other combination thereof. The display 840 may include a display panel 841 configured with a liquid crystal display (LCD), an organic light-emitting diode (OLED) or the like. Furthermore, the touch sensitive surface 831 may be configured to cover the display panel 841. When detecting the touch operation performed on or near the touch sensitive surface 831, the touch sensitive surface 831 may transmit signals to the processor 880 to determine a type of the touch operation, and then the processor 880 may provide a corresponding visual output on the display panel 841 according to the type of the touch operation. Although in FIG. 8 the touch sensitive surface 831 and the display panel 841 are configured to realize the input and output functions as two independent components, they can be integrated together in some embodiments to realize the input and output functions.

The sensor 850 may be a photo sensor, a motion sensor, or any other sensors. For example, the photo sensor may include an ambient light sensor and a proximity sensor. The ambient light sensor may adjust brightness of the display panel 841 according to intensity of the ambient light. The proximity sensor may close the display panel and/or backlight when the terminal 800 is close to the user's ear. As an example of the motion sensor, a gravitational acceleration sensor may detect values of accelerations in various directions (e.g., along three axes), may detect a value and a direction of the gravitation when being in stationary, and may be used in an application for identifying a terminal attitude (such as switching between a landscape mode and a vertical mode, corresponding games, magnetometer pose adjusting), functions related to vibration (such as a pedometer, knocking) and the like. Other sensors such as a gyroscope, a barometer, a hydrometer, a thermometer, an infrared sensor and the like which may be arranged in the terminal apparatus 800 will not be described in detailed.

The audio circuit 860 is coupled to a speaker 861 and a microphone 862, and may provide an audio interface between the user and the terminal 800. The audio circuit 860 may convert received audio data into electronic signals and transmit the electronic signals to the speaker 861, and the speaker 861 may convert the electronic signals into voice and output the voice. Additionally, the microphone 862 may convert collected voice signals into electronic signals, and the audio circuit 860 receives the electronic signals and converts them into audio data. The audio data is transmitted to the processor 880 and then is transmitted to another terminal via the communication unit 810 after processed by the processor 880, or the audio data is transmitted to the memory 820 to be further processed. The audio circuit 860 may also include an earplug jack to allow communication between a peripheral earphone and the terminal 800.

The wireless communication unit 870 may be a WiFi module configured to provide wireless broadband internet access, which allows the user to transmit or receive E-mail, browse web pages and access streaming media and the like. Although the wireless communication unit 870 is shown in FIG. 8, it should be understood that the wireless communication unit 870 is not a necessary component of the terminal 800, and may be omitted according to requirements.

The processor 880 is a control center of the terminal 800 that uses various interfaces and wires to connect respective components of the terminal 800. By running or executing software programs and/or modules stored in the memory 820, calling data stored in the memory 820, and executing various functions of the terminal 800 and processing data, the processor 880 handles overall monitoring to the terminal 800. The processor 880 may include one or more processing cores, and may integrate an application processor and a modem processor. The application processor may mainly process the operation system, user interfaces, application programs and the like, and the modem processor may mainly process wireless communications. In some embodiments, the modem processor may not be integrated into the processor 880.

The power supply 890 is configured to supply power to respective components of the terminal 800. The power supply 890 may be logically connected with the processor 880 through a power supply management system, thereby realizing functions of managing charging, discharging, power consumption, and through the power supply management system. The power supply 890 may further include one or more of a direct current (DC) power supply or an alternating current (AC) power supply, a rechargeable system, a power supply malfunction detection circuit, a power supply converter or an inverter, a power supply state indicator and the like.

Although not shown, the terminal 800 may also include a camera, a Bluetooth module, etc.

In addition, the terminal 800 includes an ITO film with patterns configured to diffuse light, and the ITO film is located in a button region of the terminal 800.

In the button region, the distribution of the patterns on buttons is denser than that on the positions without buttons.

The terminal 800 also includes at least one light emitting element which is located on a side of an extending direction of the button region. The further away the patterns are from the light emitting element, the distribution of the patterns become denser.

The ITO film includes an ITO layer, a light conducting material layer and a PET layer. The ITO layer and the light conducting material layer are respectively attached to two sides of the PET layer, and the patterns are formed on the light conducting material layer.

The terminal 800 also includes a cover glass, and the ITO film is attached to the cover glass. For example, the light conducting material layer of the ITO film is attached to the cover glass.

The terminal 800 also includes a LCD module, and the ITO thin film is provided between the cover glass and the LCD module.

The terminal 800 may be various handheld mobile terminals, such as a mobile phone, a personal digital assistant (PDA), etc. Therefore, the scope of the present disclosure is not to be limited to a certain type of terminal.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. An indium tin oxide (ITO) film, comprising:
patterns configured to diffuse light.

2. The ITO film according to claim 1, further comprising:
an ITO layer;
a light conducting material layer; and
a polyethylene terephthalate (PET) layer,
wherein the ITO layer and the light conducting material layer are respectively attached to first and second sides of the PET layer, respectively; and
the patterns are formed on the light conducting material layer.

3. The ITO film according to claim 1, further comprising:
an ITO layer; and
a polyethylene terephthalate (PET) layer.

4. A terminal, comprising:
a processor;
a memory for storing instructions executable by the processor; and
a touch panel including a transparent cover plate, an indium tin oxide (ITO) film, and a liquid crystal display (LCD) module;
wherein the transparent cover plate is attached to the LCD module; and
the ITO film is provided with patterns configured to diffuse light and is attached to the transparent cover plate, an attaching position being located in a button region of the terminal.

5. The terminal according to claim 4, wherein a distribution of the patterns corresponding to positions with buttons is denser than a distribution of the patterns corresponding to positions without buttons.

6. The terminal according to claim 4, further comprising:
at least one light emitting element located on a side of an extending direction of the button region;
wherein a distribution of the patterns corresponding to positions farther away from the light emitting element is denser than a distribution of the patterns corresponding to positions closer to the light emitting element.

7. The terminal according to claim 4, wherein the ITO film comprises:
an ITO layer;
a light conducting material layer; and
a polyethylene terephthalate (PET) layer,
wherein the ITO layer and the light conducting material layer are respectively attached to first and second sides of the PET layer, and
the patterns are formed on the light conducting material layer.

8. The terminal according to claim 7, wherein the light conducting material layer is attached to the transparent cover plate.

9. The terminal according to claim 4, wherein the ITO film comprises:
an ITO layer; and
a polyethylene terephthalate (PET) layer,
wherein the PET layer is attached to the transparent cover plate; and
concave points and convex points are provided on a side of the PET layer attached to the transparent cover plate, to form the patterns.

10. The terminal according to claim 4, wherein the transparent cover plate is a cover glass.

11. The terminal according to claim 4, wherein the ITO film is located between the transparent cover plate and the LCD module.
